(19) United States
(12) Patent Application Publication
(10) Pub. No.: US 2016/0356399 A1
(43) Pub. Date: Dec. 8, 2016

(54) TRUNNION CONTROL GATE VALVE FOR SEVERE SERVICE

(71) Applicant: Jianchao Shu, Cypress, TX (US)

(72) Inventor: Jianchao Shu, Cypress, TX (US)

(21) Appl. No.: 15/243,185

(22) Filed: Aug. 22, 2016

Related U.S. Application Data
(63) Continuation of application No. 13/526,521, filed on Jun. 19, 2012, now abandoned.
(60) Provisional application No. 61/571,049, filed on Jun. 20, 2011.

(51) Int. Cl. F16K 47/08; F16K 3/314; F16K 3/02; F16K 27/04; F16K 47/04

(52) U.S. Cl. CPC F16K 47/08; F16K 27/044; F16K 47/04; F16K 3/0209; F16K 3/314

(57) ABSTRACT

A valve, including a body comprising an inlet passageway, an outlet passageway, and a slot. In addition, the valve includes a closure member movable within the slot between a first position where the inlet passageway is in fluid communication with the outlet passageway, and a second position where fluid communication between the inlet passageway and the outlet passageway is prevented by the closure member. The closure member includes a stem portion and a gate portion, wherein the gate portion includes a port extending therethrough, and wherein the stem portion and the gate portion are formed as a single integral piece.

### CROSS-REFERENCE TO RELATED APPLICATIONS

This application is a continuation of U.S. patent application Ser. No. 13/526,521, filed on Jun. 19, 2012, and entitled “Trunnion Control Gate Valve For Sever Service,” which claims the benefit of U.S. Provisional Patent Application Ser. No. 61/571,049 filed on Jun. 20, 2011, and entitled “Trunnion Control Gate Valve For Sever Service,” the contents of each being incorporated herein by reference in their entireties, for all purposes.

### FEDERALLY SPONSORED RESEARCH

Not applicable.

### SEQUENCE LISTING OR PROGRAM

Not applicable.

### BACKGROUND

This invention relates to a novel control valve with a new gating mechanism, new flow throttling mechanisms and metal seal rings, more particularly to a trunnion control gate valve with those novel features used for on-off and flow fluid controlling under multiple extreme conditions or in sever serve; such as the rocket engine fuel control system with highly oxidative fluid under extreme temperature of 1350 F, the integrated gasification combined cycle (IGCC) under high temperature and pressure, Fluid Catalytic Cracking Unit (FCCU) under high temperature over 1200 F with hard diamond like catalytic particles, shale fracking process under extreme high pressure and high velocity fluid with solid particles and corrosive additives, other applications with flow fluid with high viscosity in field of chemical plants, or conventional power plants, refiners and oilfield, or other critical applications for products life lasting 5 to 30 years like deepsea flow control systems and nuclear power plants and for the applications of million cycles like jet or rocket turbine engine fuel delivery systems with high velocity fuel fluid mixed with high oxidative gas under temperature 1365 F or higher without failure.

This valve combines a gate valve and globe valve structures and comprises a body with at least an inlet passageway and an outlet passageway, a cylindrical neck opening and a gate with an integral part of a stem disposed in the neck opening for throttling flow fluid with a revolutionary volumetric flow mechanism and a four step throttling process, a gating mechanism with two spring bars are disposed between the gate and the neck opening to control movements of the gate and to compensate thermal expansion, misalignment and deformation under high pressure, temperature and quick thermal cycle, a noise/cavitation reducer is installed between the inlet passageway and the outlet passageway to reduce cavitation or noise, a shock absolver in the reducer can ease the water hammer and stabilize the outlet pressure. This valve is fully sealed in both static and dynamic manners by simple, reliable metal G rings under all conditions of temperature, pressure where even graphite cannot service. This valve has a simple base structure with versatile configurations for various throttling applications and is easy for manufacturing and repair, yet robust and reliable.

Conventional gate valves are mostly used for on-off or manual applications in chemical plants, power plants and refiners and oil/gas fields, they are rarely used for throttling or automation applications, while the conventional globe valves are used for both throttling and on-off, here are the existing problems (1) a gate in the gate valve trend to be float when it is away from a closed position, so such a condition can cause vibration, unstable throttling and jam (2) abrasive fracturing fluids tend to be drawn into the gate valve cavity when the gate between open and closed positions and prevent the gate from returning to the original position (3) valve seals with fragile graphite for high temperature applications are subject to excessive packing force or rubbing, constant readjustment or replacement of packing are required, moreover the seal with graphite cannot used for highly oxidative fluids with temperature over 850 F, in case of subsea flow control devices or nuclear power plants, or jet engine fuel delivery system sometime the constant readjustment is impracticable, on the other hand the metal ring joint seal for high pressure are subject to the highly preloaded bolting forces, extensive large bolts and constant readjustment are required (4) the throttling mechanism for the conventional control globe valves is based on the area throttling mechanism, which means the flow rate change is based on the change of flow cross sectional area, the major disadvantage for the mechanism is that it causes the vena contracta, in consequence the vena contracta causes cavitation and flashing, moreover the low flow throttling resolution and the minimum leakage are the shortcoming of globe valve and prevents the globe valve for more demanding applications under multiple extreme conditions. As a result, total consumption of conventional gate and globe valves have been declined for last 30 years, most of those applications are replaced by ball valve as well as butterfly valve.

In order to overcome the disadvantages or solve the problems of the conventional gate and globe valves, many efforts have been made in the prior arts. There are four approaches to improve the conventional valves, but those approaches work within a limited scope.

The first approach is to improve movement of the gate when it is away from the closed position, U.S. Pat. No. 5,836,569 to David Wurangian (1997) shows a classic approach to solve the problem by using the tongue and groove structure between the gate and the body, U.S. Pat. No. 751,735 to S. S Jacobsen (1904) shows a similar approach on the trail and the gate. U.S. Pat. No. 7,201,361 to Grandage; Ronald Ellis (2007) disclosed a design for rubber lining gate valve (resilient gate valve) between the gate and the body, the fundamental disadvantage for tongue and groove structure is only to guide the gate not precisely hold or position the gate, so it only work for rubber lining gate valve with as-cast body and gate under ambient temperature, the rubber will compensate misalignment and wearing between the gate and the body, but for a metal to metal engagement with a precise fit, the tongue and groove structure can not compensate any misalignment or deformation, thermal expansion between the moving gate and the body under high temperature or high pressure and will prevent the gate from moving freely between open and closed positions, moreover in case of solid particles entering between the tongue and groove, the gate will be seized, in addition the manufacturing for metal tongue and groove with the precise fit is difficult and expensive, even more difficult if the hardened face is applied to the gate as well as the body, so far there is no commercially successful products with such a structure under high pressure and high temperature, so loose guiding with the tongue and groove structure is only a solution for now.

The second approach is to develop structures which prevent particles in the flow into the valve cavity, for example, in U.S. Pat. No. 2,230,600 to C. A Olson (1941) a pair of long seat sleeves (guide) was employed, it is fixed with seat and covers the gate travel from closed to open positions. Most of other prior-arts have the similarly approach, the problem for the design is that the sleeve as a integral part of the seat, so any buildup or damage on the sleeve will cause leak, if the seat is float and supported by spring, any unbalanced force on both end of sleeve can jam the seat and cause leak.

The third approach is to improve valve seals. The stem packing is one of those efforts shown in U.S. Pat. No. 4,886,241 to James R. Davis et al (1989) and U.S. Pat. No. 4,394,023 to Alberto L. Hinojosa (1983) disclose stem seals with graphite packing for high temperature applications, but the stem packing seals are subject to more packing force and constant readjustment. A recent survey shows that 50% of the control valve failures are contributed by excessive stem packing force. U.S. Pat. No. 7,004,452 to Chatufale (2006) shows C ring seal for gate valve, but it is unidirectional and not for high temperature, while U.S. Pat. Application No. 201110084456 A1 reveals a metal C ring with a insert for high temperature flange seal application, but the C ring only is used for static seal in flanges.

The fourth approach is to ease effect of the vena contracta by reducing cavitation and noise for throttling application. The early efforts were made by F. C Mock in U.S. Pat. No. 1,144,306 (1915) and L. H Skeels (1922) in U.S. Pat. No. 1,432,797 for improving muffler function, but first of all the muffler is only used for sound control and does not reflect liquid application like cavitation and erosion, second the welding process make the set of pipes as one piece object, one piece object is very difficult to cancel out vibration within the object, beside that, welding place is susceptible to erosion and corrosion. Finally a valve applications is shown in U.S. Pat. No. 4,007,908 to Paul V. Smagghe. In short, all efforts in the prior arts never address or recognize the area throttling mechanism is the root cause of cavitation and flashing, most efforts are focused on easing the cavitation, noise rather than finding the root of cause. In general, a control valve with anti-cavitation or noise reduction function has about 40% of flow capacity in comparison with the same size of the standard valve without anti-cavitation or noise reduction function.

So the flow control industry has long sought means of improving the performance of control valve, increasing the resolution of flow metering, inventing a new throttling mechanism, improving the valve seals, enabling gate valve to throttle flow with versatile flow characteristics under multiple extreme conditions, increase life of the control valve and reliability and accuracy of flow throttling.

In conclusion, insofar as I am aware, no such control gate valve is formerly developed with higher metering resolution, long life, less parts, highly efficient, sealable durable, robust, versatile, reliable, easy manufacturing at low cost they can be used for controlling fluid between full opening and full closed positions with no or less cavitation and low noise under multiple extreme conditions or sever service.

### SUMMARY

This invention provides a simple, robust, reliable and versatile control gate valve for server service or under multiple extreme conditions. This control gate valve comprises a body with an inlet passageway, outlet passageway, a cylindrical neck opening and two seat pockets, at least one seat is disposed in the seat pocket, a gate with a stem is disposed in the neck opening by means of a gating mechanism for controlling fluid flow between the passageways under high temperature, high pressure and extreme flow conditions, the gating mechanism with two spring bars are disposed between the gate and the neck opening to control the gate and compensate any misalignment, thermal expansion between the gate and the body. A novel seal assembly, G ring is constructed as a metal cover ring with a base ring which can be a part of seat back seal and bonnet flange seal or an independent stem seal in the control gate valve, G ring comprises the metal cover ring with C shaped cross section and the base ring with an I shaped cross section inserted into C ring for providing static and dynamic seals on three external surfaces and four internal surfaces under high temperature and high pressure with the leakage between 5-100 ppm.

This valve can be modified with an angle body, porous flow ports on the seat and the gate and the gate with a bottom tip, it comprises a new four-step throttling process; (1) sealing (2) metering (3) conditioning (4) delivering, the new procedure divides the gate to four parts, sealing part, metering part, conditioning part and delivery part, the conditioning between the neck opening and the gate can stabilize the throttling flow pressure and velocity for the delivery, the delivery process happens between bottom a tip of the gate and the outlet passageway, such a throttling mechanism fundamentally changes the traditional process, it prolongs the life of the gate and improves the metering quality, even erosion takes place on the delivering part of the gate, the metering and seal parts still work well, a good application will be a fuel delivery system for jet or turbine engines.

This valve can be modified with two seats having a stepped, multiple—circular flow pattern on the gate, a bottom of the gate is disposed in a stepped cage, as the gate moves vertically, a flow volume between them are changed, with such a volume throttling mechanism, the cavitation will can be eliminated or reduced, the noise can be reduced greatly in contrary to the conventional area throttling mechanism, any flow characteristics can be formed, specially for dual equal percentage pattern, it is very useful for a known set point process control (like a temperature, a ratio or volume).

This valve can be modified with three way design, two inlet passageways with one outlet passageway for mixing fluids, or one inlet with two outlets for diverting a fluid, a steam conditioning valve based on this control gate valve can be constructed for multiple stage of superheat steam cooling, a first inlet passageway for steam throttling at temperature T1, a second inlet passageway is used for mixing water with the steam at temperature T2, a third inlet passageway for spraying water into steam at temperature T3, a fourth inlet passageway can be used for spraying nozzles, a first outlet passageway is for delivering conditioning steam, a second outlet passageway is used for circulation of the water in the body to keep a constant temperature of T2, this design puts the cooling process in a fully control environment and greatly reduces energy consumption, the cooling of superheat steam is no longer an art but science, the conditioning valve can be used for fuel inject valve with multiple stage of content mixing.

The noise/cavitation reducer is other feature for the control gate valve to reduce cavitation and noise level, it comprises a reducer and shock absorber, the reducer comprise a set of concentric pipes with outside surfaces and inside surfaces, outside surfaces have walls, grooves and slots for forming axial 90 degree, zigzag passageways to dissipate flow energy gradually and insulating from noise source, inside surfaces receive a next smaller pipe with stop step and press fit, the set of pipes can arranged in a step, telescope manner, so sine vibration can be generated on one pipe can cancel out the vibration with different phrase on the next pipe, such a design will reduce number of pipes and length of the pipes with most efficient result, the smallest pipe can receive the shock absorber, the shock absorber comprises a front piston and a back piston energized by a spring can ease pressure surge or drop and stabilize the outlet pressure by storing and releasing flow energy.

This valve can be modified with two lock grooves and a pair of short sleeves for solid particle proof application, two pair of sleeves are installed below and above the seats and energized by springs, the seats and sleeves are constantly respectively engaged with the gate during the gate travel between full open to fully closed positions, so no solid particles can enter into the valve cavity, since the seat and sleeve are installed separately, the seat only acts as a sealing device, while the sleeve can be constructed as scrapers to clean up the gate with strong spring, hard material, finally the valve can be constructed as a balanced stem valve with top and bottom stems between the gate, so it will be very useful for high pressure application.

Accordingly, besides objects and advantages of the present invention described in the above patent, several objects and advantages of the present invention are:

(a) To provide a control gate valve with a gating mechanism, so such a valve can control the flow between fully opening to fully closed position for sever service and has long life and high reliability.
(b) To provide highly sealable, reliable seals for multiple extreme conditions: high pressure, cryogenic or high temperature or solid particles with corrosive fluid. Such a seal assembly can keep good static and dynamic seals with low leakage between 5-100 ppm with low friction.
(c) To provide a control valve with a four step throttling process; (1) sealing, (2) metering (3) conditioning (4) delivering, so such a valve not only provide precision flow throttling as well shutoff, but also has long life and high reliability for sever service.
(d) To provide a spring seat for a control valve, such a valve has simple and high reliable seal for serve services or multiple extreme conditions.
(e) To provide a volumetric throttling mechanism in a control valve, so the valve can provide stable precise flow with less or no cavitation and low noise level and has long life for sever service.
(f) To provide a control valve with various flow characteristics, specially for dual equal percents for a set point control. Such a valve has a stable control range with less turning time and cost
(g) To provide a highly efficient noise/cavitation reducer in a flow control system, so such a reducer has a compact, simple structure with a self vibration canceling and shock absorbing functions.
(h) To provide a metering valve or fuel injection device for engines, so the engines have stable metering performance and higher fuel efficiency with low cost.
(i) To provide a highly efficient steam conditioning valve for power plant. Such a valve can cool the superheat steam with low cost, less steam and water and has long life and high reliability.
(j) To provide a control valve with solid particles proof function, so such a valve can handle slurry fluid or fluid with solid particles under high temperature and high pressure.
(k) To provide a fluid control valve with a balanced stem arrangement, so such a valve can use less actuation force and a stem seal in the valve can be replaced under pressure in both fully open position and fully closed position.

Still further objects and advantages will become apparent from study of the following description and the accompanying drawings.

### DRAWINGS

### Drawing Figures

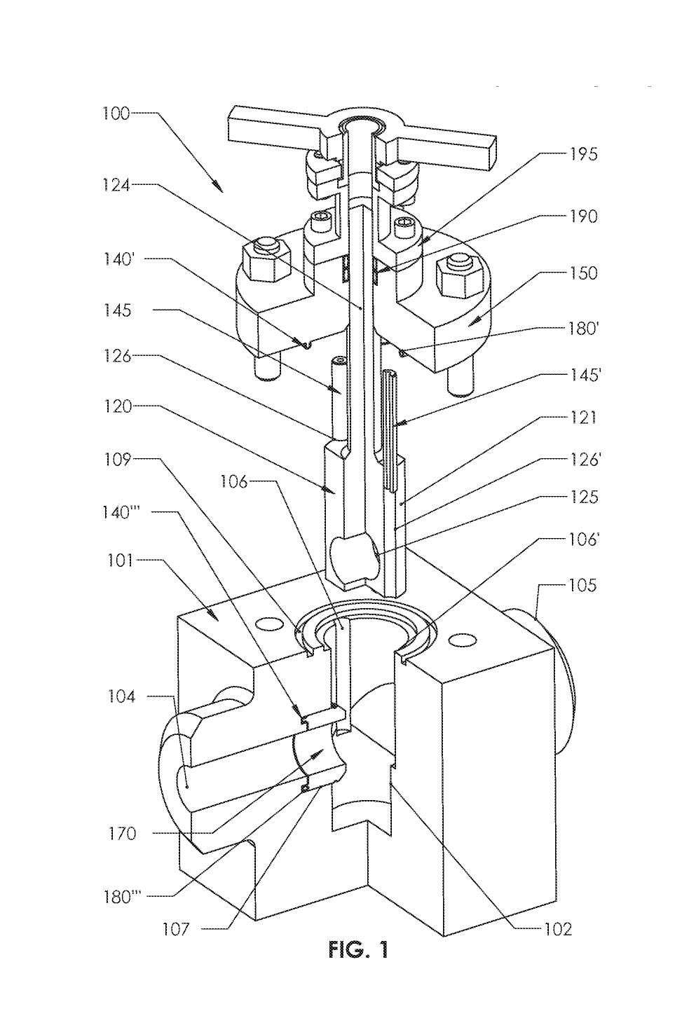

FIG. 1 is an exploded, quarter cut view of a gate valve constructed in accordance with this invention.

FIG. 2 is a front view of gate valve of FIG. 1.

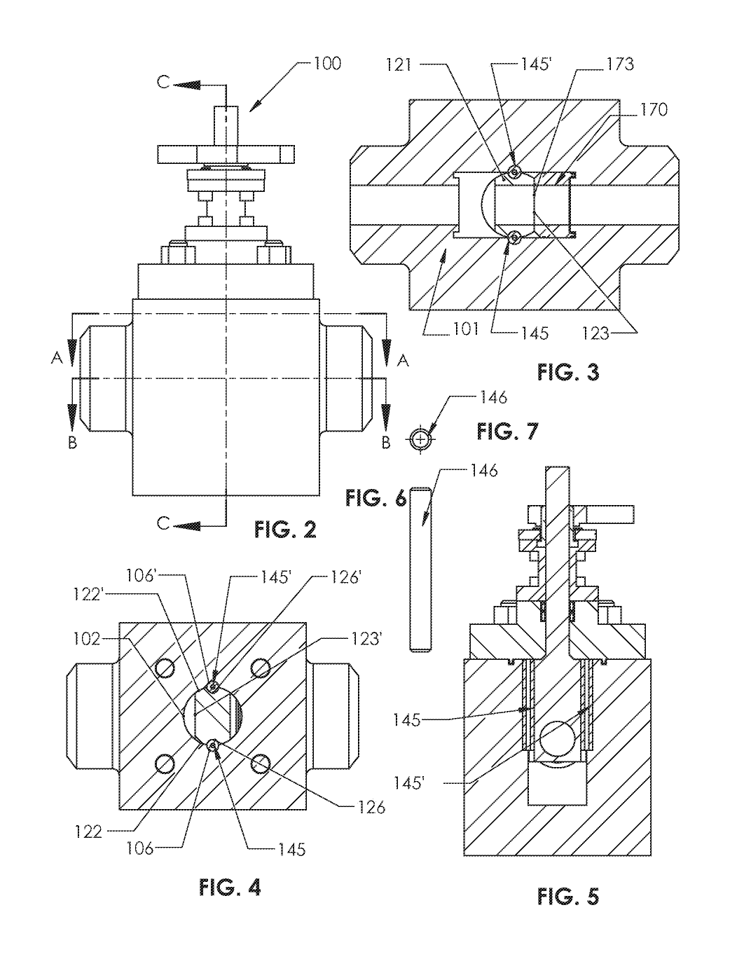

FIG. 3 is a cross sectional views of gate valve of FIG. 2 along line B-B.

FIG. 4 is a cross sectional views of gate valve of FIG. 2 along line A-A.

FIG. 5 is a cross sectional views of gate valve of FIG. 2 along line C-C.

FIG. 6 is a front view of an alternative support bar in the gate valve of FIG. 1.

FIG. 7 is a top view of support bar in the gate valve of FIG. 6.

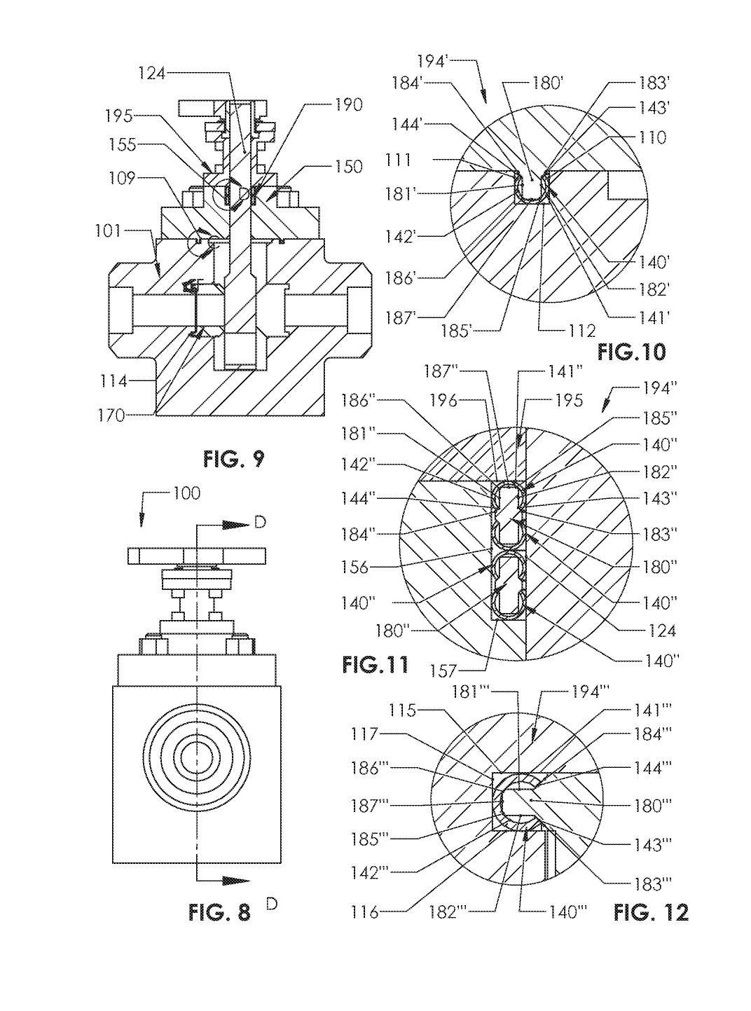

FIG. 8 is a side view of gate valve of FIG. 1.

FIG. 9 is a cross sectional views of gate valve of FIG. 8 along line D-D.

FIG. 10 is a detail views of gate valve of FIG. 9

FIG. 11 is a detail views of gate valve of FIG. 9

FIG. 12 is a detail views of gate valve of FIG. 9

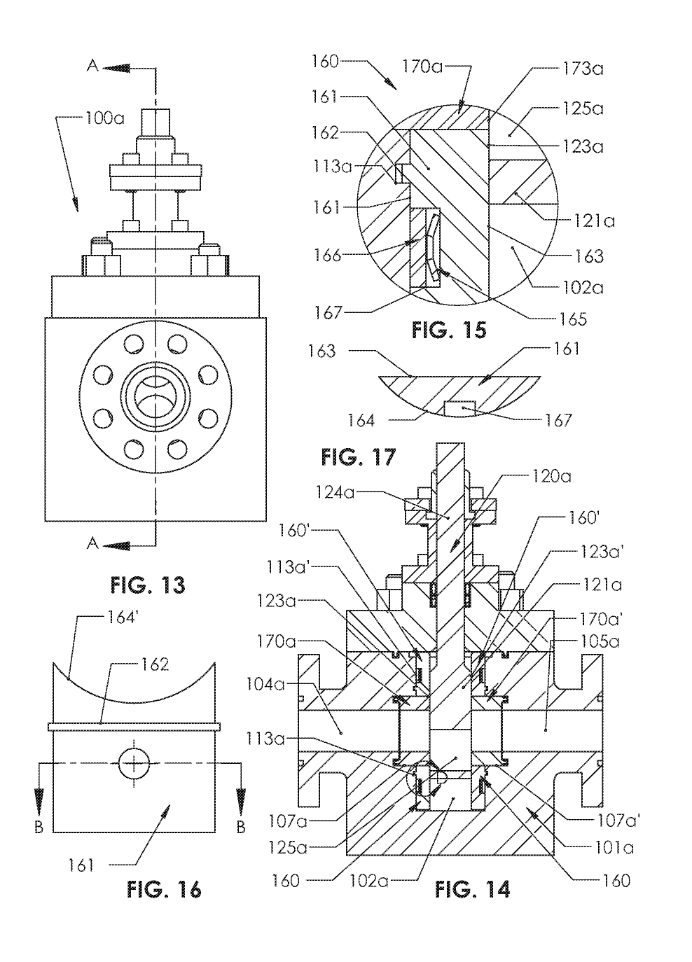

FIG. 13 is a side view of an alternative gate valve of FIG. 2

FIG. 14 is a cross sectional view of gate valve of FIG. 13 along line A-A.

FIG. 15 is a detail view of gate valve of FIG. 14

FIG. 16 is a front view of sleeve of FIG. 14

FIG. 17 is a cross sectional view of sleeve of FIG. 16

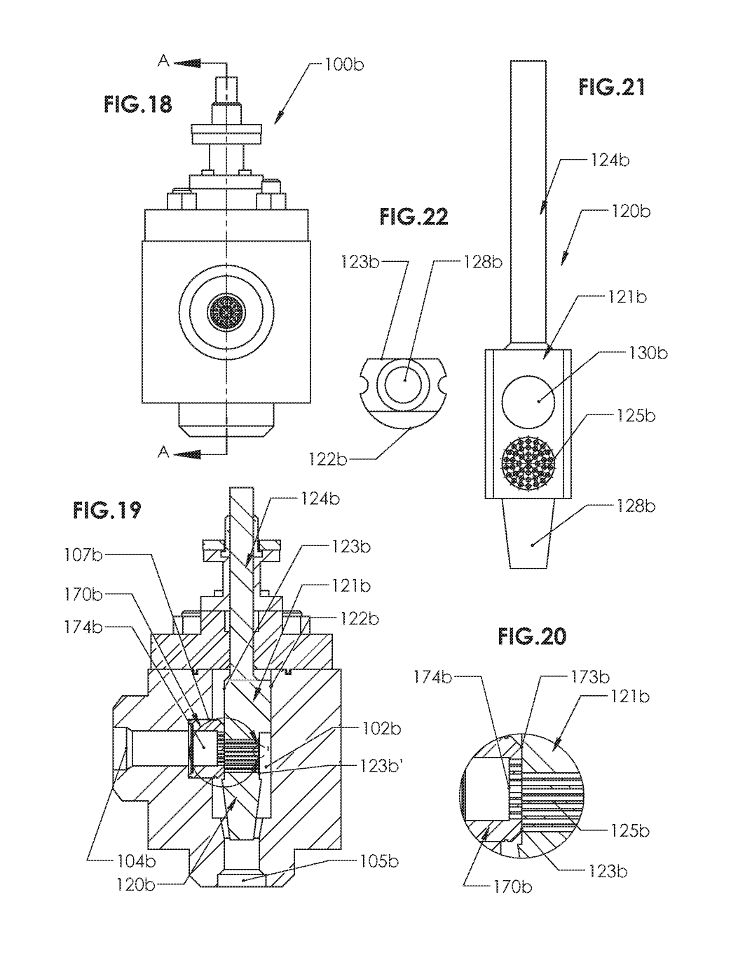

FIG. 18 is a side view of an alternative gate valve of FIG. 2

FIG. 19 is a cross sectional view of gate valve of FIG. 18 along line A-A.

FIG. 20 is a detail view of gate valve of FIG. 19

FIG. 21 is a front view of closure member of FIG. 19

FIG. 22 is a bottom view of closure member of FIG. 21

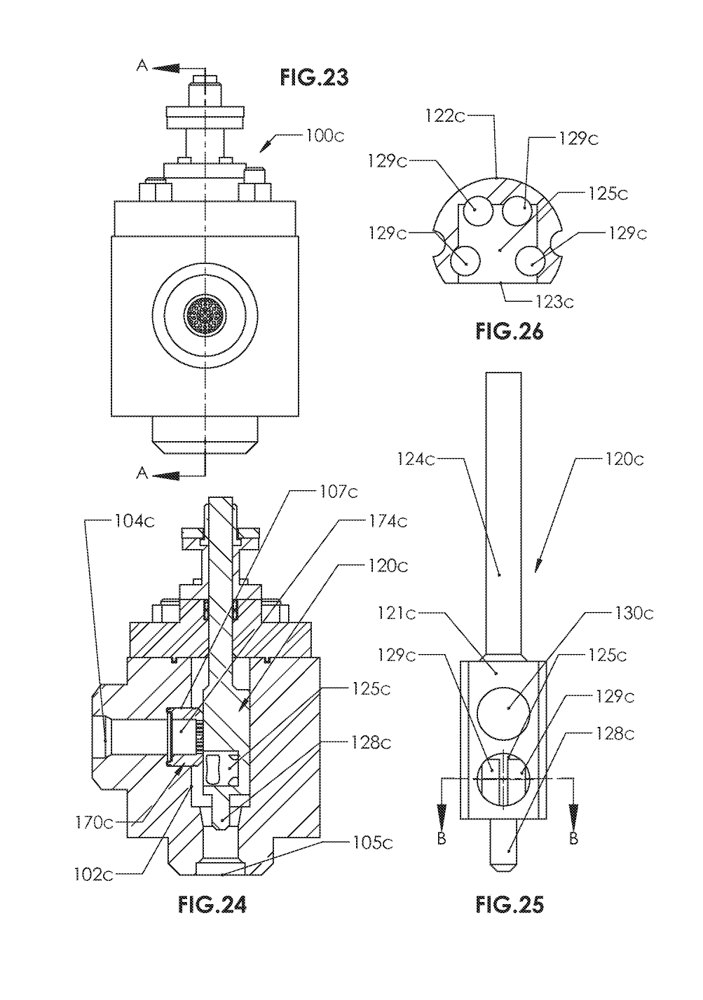

FIG. 23 is a side view of an alternative gate valve of FIG. 2

FIG. 24 is a cross sectional view of gate valve of FIG. 23 along line A-A.

FIG. 25 is a front view of closure member of FIG. 24

FIG. 26 is a cross sectional view of gate of FIG. 25 along line B-B.

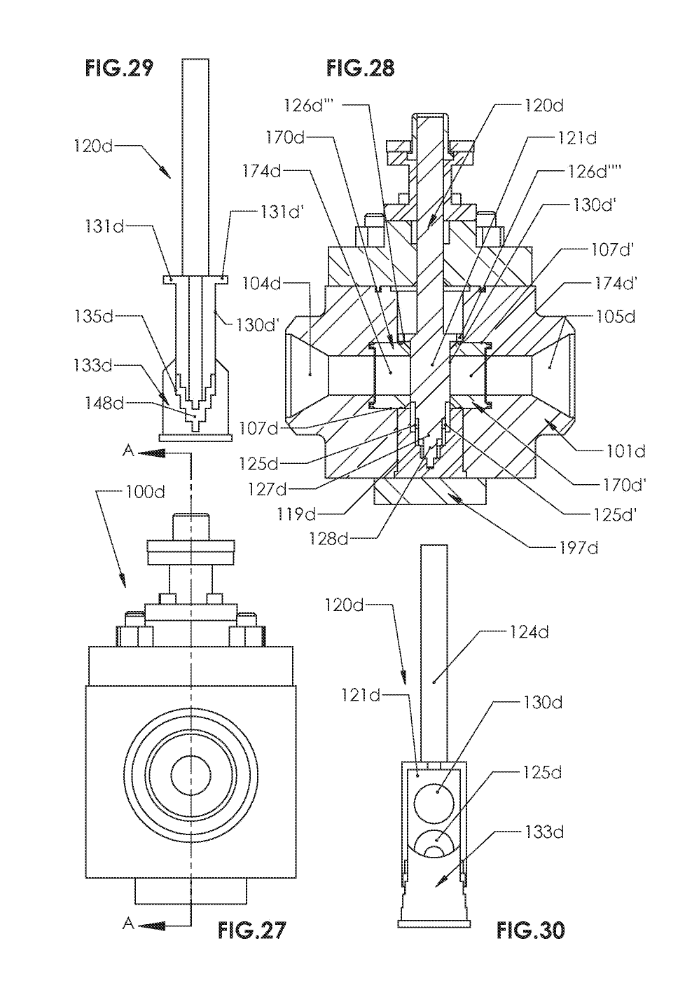

FIG. 27 is a side view of an alternative gate valve of FIG. 2

FIG. 28 is a cross sectional view of gate valve of FIG. 27 along line A-A.

FIG. 29 is a side view of cage/closure member of FIG. 28

FIG. 30 is a front view of cage/closure member of FIG. 29

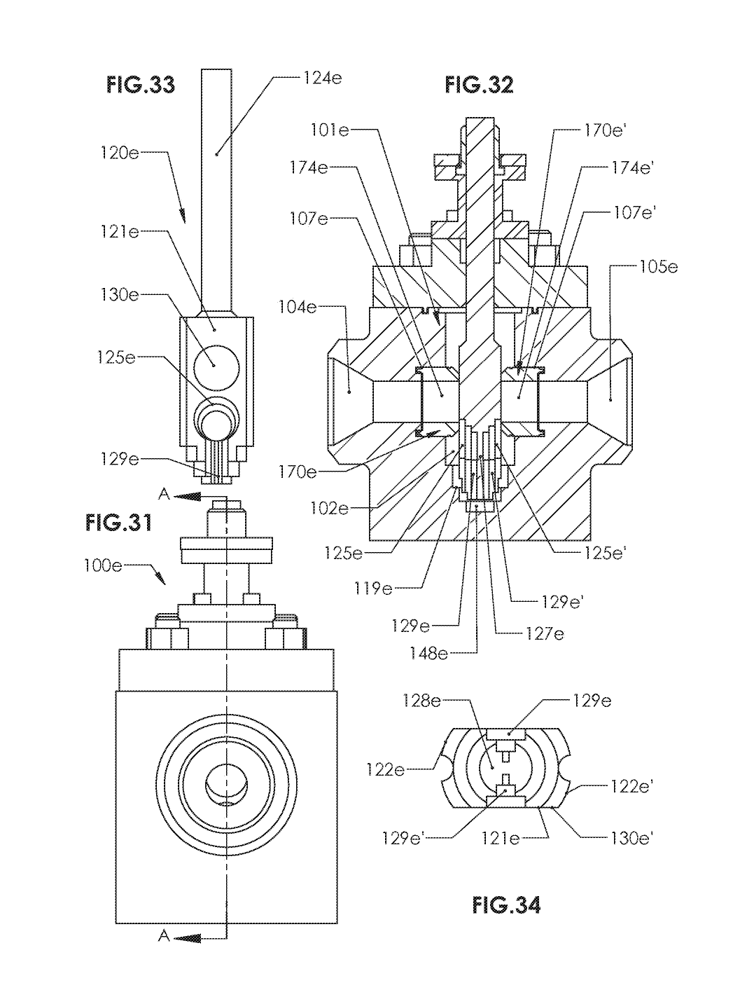

FIG. 31 is a side view of an alternative gate valve of FIG. 2

FIG. 32 is a cross sectional view of gate valve of FIG. 31 along line A-A.

FIG. 33 is a front view of closure member of FIG. 32

FIG. 34 is a bottom view of closure member of FIG. 33

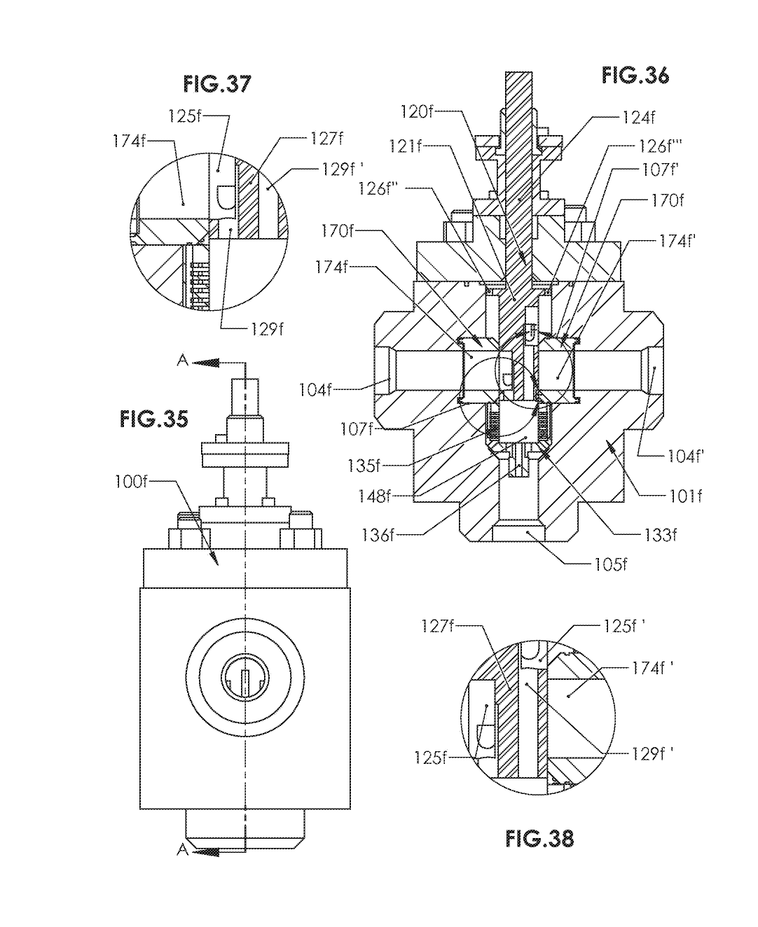

FIG. 35 is a side view of an alternative gate valve of FIG. 2

FIG. 36 is a cross sectional view of gate valve of FIG. 35 along line A-A.

FIG. 37 is a detail view of gate valve of FIG. 36.

FIG. 38 is a detail view of gate valve of FIG. 36.

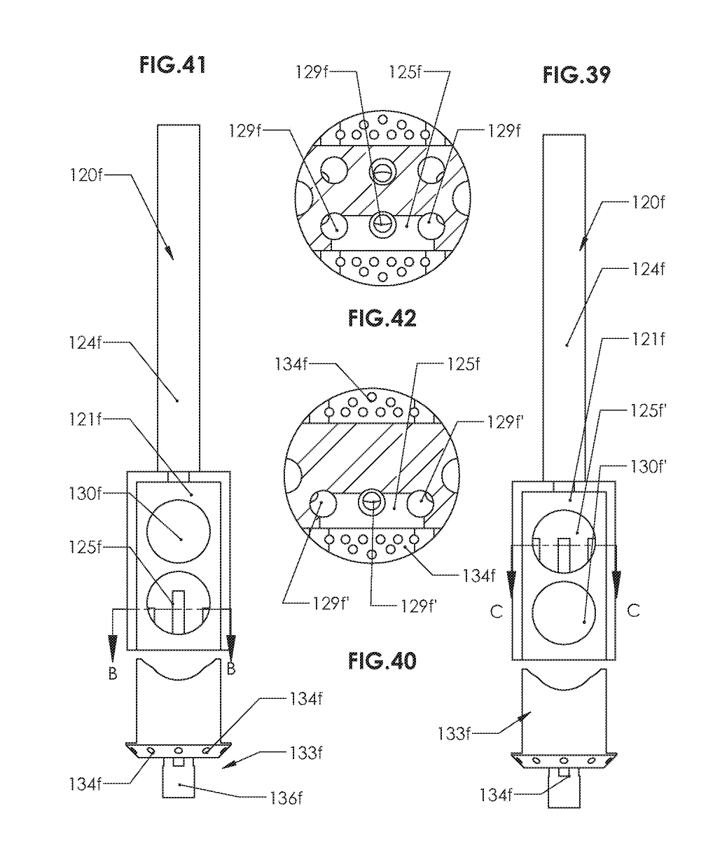

FIG. 39 is a front view of closure member/cage of FIG. 36.

FIG. 40 is a cross sectional view of closure member of FIG. 39 along line C-C.

FIG. 41 is a back view of closure member/cage of FIG. 39.

FIG. 42 is a cross sectional view of closure member of FIG. 41 along line B-B

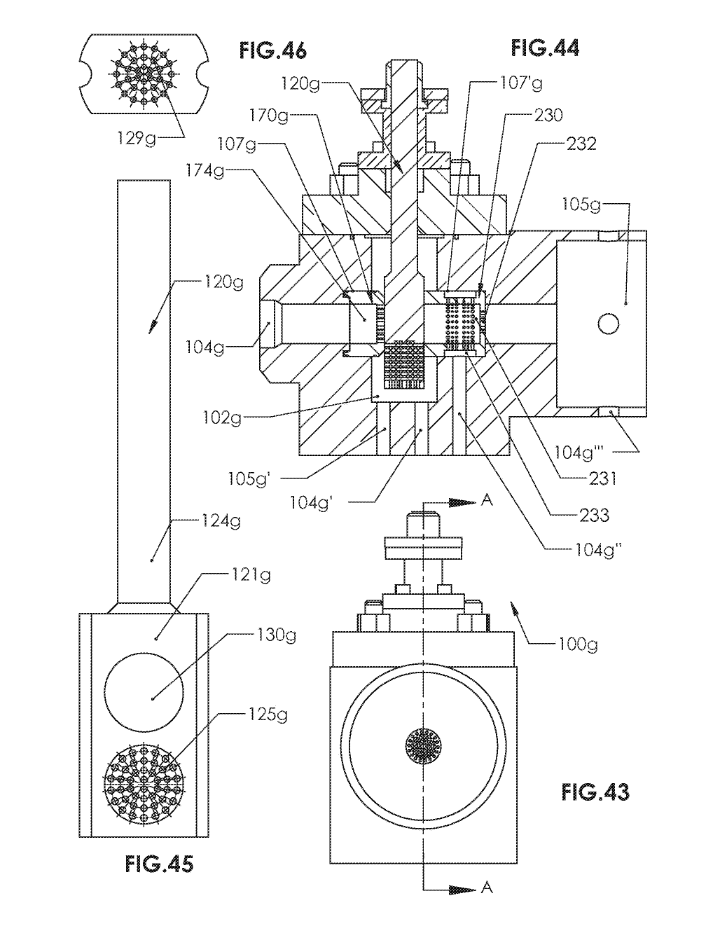

FIG. 43 is a side view of an alternative gate valve of FIG. 2

FIG. 44 is a cross sectional view of gate valve of FIG. 43 along line A-A.

FIG. 45 is a front view of closure member of FIG. 44.

FIG. 46 is a bottom view of closure member of FIG. 45.

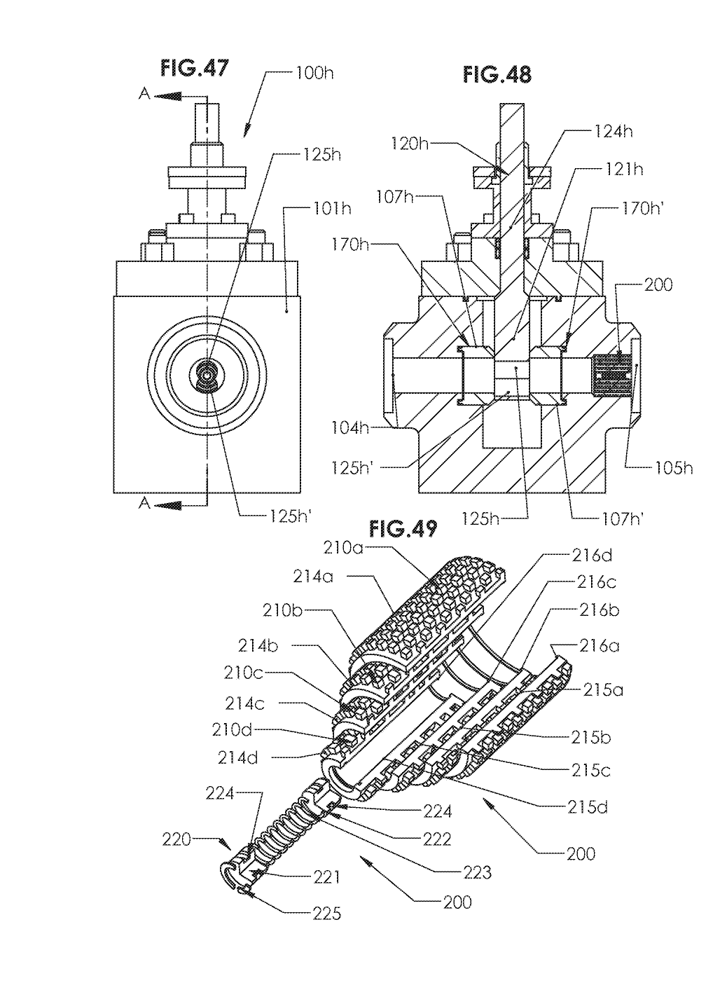

FIG. 47 is a side view of an alternative gate valve of FIG. 2.

FIG. 48 is a cross sectional view of gate valve of FIG. 47 along line A-A.

FIG. 49 is an exploded view of noise/cavitation reducer of FIG. 48.

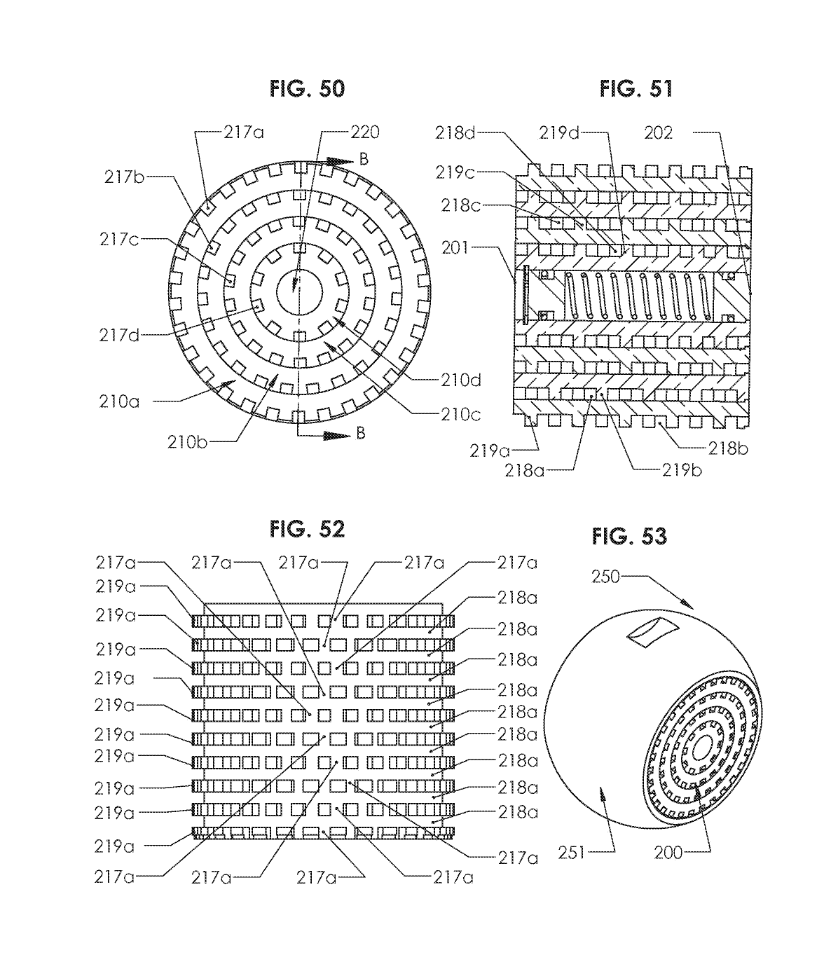

FIG. 50 is a side view of noise/cavitation reducer of FIG. 48.

FIG. 51 is a cross sectional view of reducer of FIG. 50 along line B-B.

FIG. 52 is a top view of reducer of FIG. 50.

FIG. 53 is an exploded view of noise/cavitation of FIG. 50 in a ball

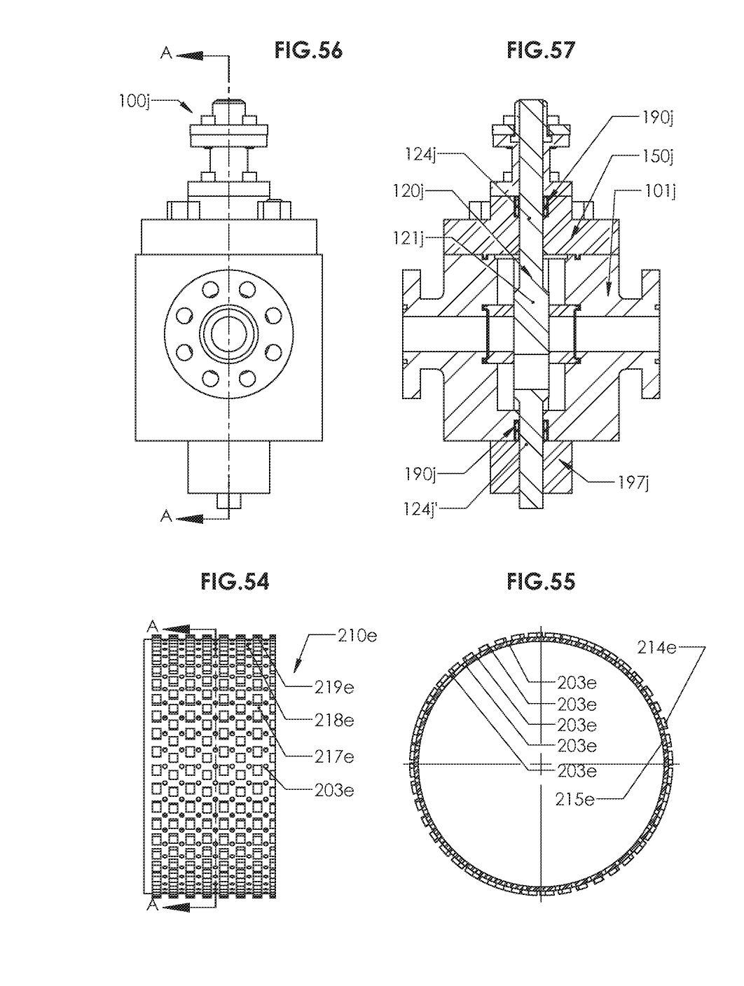

FIG. 54 is a side view of an alternative pipe of FIG. 50

FIG. 55 is a cross sectional view of pipe of FIG. 54

FIG. 56 is a side view of an alternative gate valve of FIG. 2

FIG. 57 is a cross sectional view sectional of gate valve of FIG. 55 along line A-A.

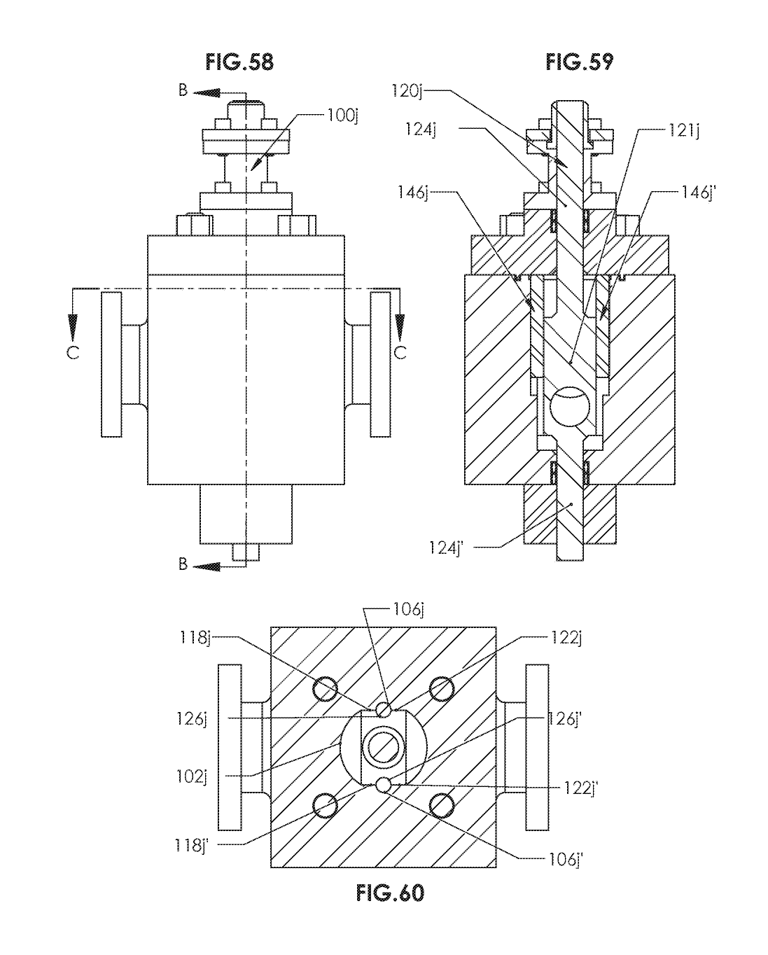

FIG. 58 is a front view of gate valve of FIG. 56

FIG. 59 is a cross sectional view of gate valve of FIG. 58 along line B-B.

FIG. 60 is a cross sectional view of gate valve of FIG. 58 along line C-C.

Reference Number In Drawing

| | |
|---|---|
| 100 | Control Gate valve a, b, c, d, e, f, g, h, j |
| 101 | body |
| 102 | neck opening inlet passageway 104′, |
| | 104 104″, 104′″ |
| 105 | Outlet passageway, 105′, 105″ |
| 106 | neck opening slot, 106′ |
| 107 | seat pocket 107 |
| 108 | Top surface |
| 109 | Bonnet C ring groove |
| 110 | ID surface |
| 111 | OD surface |
| 112 | Bottom surface |
| 113 | lock groove, 113′ |
| 114 | Seat C ring groove |
| 115 | ID surface |
| 116 | OD surface |
| 117 | Bottom surface |
| 118 | Mating surface |
| 119 | bottom hole |
| 148 | Cavity |
| 120 | Closure member |
| 121 | gate |
| 122 | mating surface 122′ |
| 123 | flat sealing surface 123′, |
| 124 | stem |
| 125 | port, 125′, 125″ |
| 126 | slot 126′, 126″, 126′″, 126″″ |
| 127 | port wall |
| 128 | gate tip |
| 129 | link port |
| 130 | seal area |
| 131 | shoulder |
| 133 | cage |
| 134 | cage hole |
| 135 | cage slot |
| 136 | cage boss |
| 140 | Cover, C ring, 140′, 140″, 140′″ |
| 141 | external surface |
| 142 | internal surface |
| 143 | inward surface |
| 144 | outward surface |
| 145 | hollow bar, 145′ |
| 146 | solid bar |
| 147 | step bushing |
| 150 | bonnet |
| 151 | Seat C ring groove |
| 152 | ID surface |
| 153 | OD surface |
| 154 | Bottom surface |
| 155 | stem pocket |
| 156 | ID surface |
| 157 | Bottom surface |
| 158 | stem hole |
| 159 | flange surface |
| 160 | Sleeve Assembly, 160′ |
| 161 | Sleeve, 161′ |
| 162 | lock ring |
| 163 | flat surface |
| 164 | Cylindrical surface, 164′ |
| 165 | spring |
| 166 | support plate |
| 167 | spring hole |
| 170 | seat |
| 148 | cavity |
| 173 | front surface |
| 174 | flow port |
| 175 | link port |
| 180 | Base, I ring 180′, 180″, 180′″ |
| 181 | OD surface |
| 182 | ID surface |
| 183 | inward base surface |
| 184 | outward base surface |
| 185 | inward edge surface |
| 186 | outward edge surface |
| 187 | end surface |
| 190 | stem seal packing |
| 195 | cover |
| 196 | bottom surface |
| 197 | Bottom flange |
| 198 | stem hole |
| 200 | Noise/cavitation reducer |
| 201 | Reducer inlet |
| 202 | Reducer outlet |
| 203 | radial hole |
| 210 | axial pipe a, b, c, d, e |
| 211 | ring base |
| 212 | Pipe inlet |
| 213 | Pipe outlet |
| 214 | outside surface |
| 215 | inside surface |
| 216 | step |
| 217 | pass slot |
| 218 | groove seal assembly, G ring 194 |
| | 194′, 194″, 194′″ |
| 220 | shock absorber |
| 219 | wall |
| 221 | front piston |
| 222 | back piston |
| 223 | spring |
| 224 | o ring |
| 225 | retaining ring |
| 230 | water spray ring |
| 231 | wall port |
| 232 | front port |
| 233 | groove |
| 250 | ball assembly with reducer |
| 251 | ball |

### DESCRIPTION

FIGS. 1-12 illustrate a control gate valve constructed in accordance with the present invention. The valve 100 comprises a body 101 having a cylindrical neck opening 102 with two cylindrical axial slots 106,106′ in an opposite direction and extended to an inlet passageway 104 and an outlet passageway 105, a closure member 120 having a stem 124 and a gate 121 having a port 125 and two axial cylindrical slots 126,126′ in an opposite direction is movably disposed in opening 102 by means of two cylindrical mating surfaces 122,122′ and two hollow cylindrical support bars 145,145′ engaged respectively with cylindrical slots 126, 106, and 126′,106′ for throttling flow fluid through inlet passageway 104, a seat 170 and outlet passageway 105 between fully closed and fully open positions.

The inlet passageway 104 includes a seat pocket 107 to receive seat 170, one of flat surfaces 123,123′ of gate 121 is engaged with a front surface 173 of seat 170 for providing a seal, support bar 145 can be constructed as solid round bar 146 or a spiral pin (not shown) in special conditions.

Referring FIGS. 9,10, a bonnet 150 mounted on a top surface 108 of body 101 comprises a base ring 180′ having an I shaped cross section, a seal assembly 194′, G ring includes a cove ring 140′ having C shaped cross section receiving the base ring 180′, the base ring 180′ is defined by an OD surface 181′, an ID surface 182′, an inward shoulder surface 183′, an outward shoulder surface 184′, an inward edge surface 185′, an outward edge surface 186′ and an end surface 187′. Cover ring 140′ disposed in a groove of 109 of surface 108 has an external surface 141′ engaged with surfaces 110,111,112 for providing seals, an inwards mating surface 143′ engaged with surface 183′ for providing a seal, an outward mating surface 144′ engaged with surface 184′ for providing a seal, an internal surface 142′ engaged with surfaces 185′, 186′ for providing seals under compression.

Referring FIGS. 9,11, bonnet 155 also includes a stem hole 158 extended to a stem pocket 155 to receive stem 124, a stem seal packing 190 disposed in pocket 155 of bonnet 150 and restrained by stem 124 and a bottom surface 196 of a cover 195 comprises two seal assemblies 194″ in series for providing seals. Seal assembly 194″ comprises a base ring 180″ having a tandem I cross section inserted respectively into a pair of cover rings 140″, the base ring 180″ includes two OD surfaces 181″, two ID surfaces 182″, two inward base surfaces 183″, two outward shoulder surfaces 184″, two inward edge surfaces 185″, two outward edge surfaces 186″ and two end surfaces 187″ in an axially opposite direction, cover ring 104″ disposed between seat pocket 155 and stem 124 has an external surface 141″ engaged with stem 124, surfaces 156,157,196 and other cover ring 104″ for providing seals, an inwards mating surface 143″ engaged with surface 183″ for providing a seal, an outward mating surface 144″ engaged with surface 184″ for providing a seal, an internal surface 142″ engaged with surfaces 185″, 186″ for providing seals under compression.

Referring FIGS. 9,12, seat 170 comprises a base ring 180′″, a seal assembly, G ring 194′″ comprises a cover ring 140′″ with C shaped cross section and the base ring 180′″ with an I shaped cross section inserted into C ring 140′″, base ring 180′″ includes an OD surface 181′″, an ID surface 182′″, an inward shoulder surface 183′″, an outward shoulder surface 184′″, an inward edge surface 185′″, an outward edge surface 186′″ and an end surface 187′″. Cover ring 140′″ disposed in groove of 114 of body 101 has an external surface 141′″ engaged with surfaces 116,115,117 for providing seals, an inwards mating surface 143′″ engaged with surface 183′″ for providing a seal and support, an outward mating surface 144′″ engaged with surface 184′″ for providing a seal and support, an internal surfaces 142′″ engaged with surfaces 185′″, 186′″ for providing seals under compression.

Referring FIGS. 13-17, a valve 100a based on valve 100 comprises a body 101a having a cylindrical neck opening 102a extended to an inlet passageway 104a and an outlet passageway 105a and two lock grooves 113a, 113a′ located respectively below and above the inlet passageway 104a and outlet passageway 105a, the inlet passageway 104a and outlet passageway 105a respectively have seat pockets 107a,107a′ in an opposite direction for receiving respectively two seats 170a,170a′. A closure member 120a having a stem 124a and a gate 121a having a port 125a and flat sealing surfaces 123a,123a′ is movably disposed in neck opening 102a for throttling flow fluid through inlet passageway 104a, port 125a, two seat 170a,170a′ and outlet passageway 105a between fully closed and fully open positions.

Two pair of substantially similar sleeve assemblies 160,160′ are mounted respectively above and below seats 170a, 170a′ for preventing solid particles through a port 125a into opening 102a, each of a pair of sleeves 161 includes a flat surface 163 against surfaces 123a,123a′ of gate 120a for preventing any solid particles into opening 102 from port 125a when gate 124a between open and closed positions, sleeve 161 has a cylindrical mating surface 164′ mated with seat 170a, a cylindrical mating surface 164 engaged with opening 102a and a lock ring 162 inserted in groove 113a for preventing any vertical movement and a hole 167 to receive a spring 165 and a support plate 166 for energizing sleeve 161 against gate 120a.

Referring to FIGS. 18-22, a valve 100b based on valve 100 comprises an angle body 101 b having a cylindrical neck opening 102b extended to an outlet passageway 105b and an inlet passageway 104b with a seat pocket 107b receiving a seat 170b. A closure member 120b constructed by two parts of a stem 124b and a gate 121 b with a surface 122b is movably disposed in neck opening 102b for throttling flow fluid through inlet passageway 104b, a porous port 174b of seat 170b, opening 102b and outlet passageway 105b between fully closed and fully open positions.

Gate 121b has a circular seal area 130b on a surface 123b, a porous port 125b and a tip 128b, seal area 130b is provided for a seal between gate 121b and seat 170b at a closed position, port 125b is communicated with port 174b for metering the flow fluid, while tip 128b moves vertically in opening 102b and outlet passageway 105b for conditioning and delivering the flow fluid.

Referring to FIGS. 23-26, a valve 100c based on valve 100 comprises an angle body 101 c having a cylindrical neck opening 102c extended to an outlet passageway 10Sc and an inlet passageway 104c with a seat pocket 107c receiving a seat 170c, A closure member 120c having a stem 124c and a gate 121c as an integral part with a surface 122c is movably disposed in neck opening 102c for throttling flow fluid through inlet passageway 104c, a porous seat port 174c, link ports 129c and outlet passageway 10Sc between fully closed and fully open positions.

Gate 121c has a circular seal area 130c on a surface 123c, a port 12Sc connected to link ports 129c and a tip 128c, seal area 130c is provided for a seal between gate 121c and seat 170c, port 12Sc is communicated with port 174c for metering the flow fluid, while tip 128c is moves vertically in opening 102c and outlet passageway 10Sc for conditioning and delivering the flow fluid.

Referring to FIGS. 27-30, a valve 100d based on valve 100 comprises a body 101 d having a cylindrical neck opening 102d extended to an inlet passageway 104d and an outlet passageway 105d respectively having seat pockets 107d,170d′ for receiving seats 170d, 170d′. A closures member 120d having a stem 124d and a gate 121d is movably disposed in neck opening 102d with two shoulders 131d, 131d′ for throttling flow fluid volume through inlet passageway 104d, seat ports 174d,174d′ and outlet passageway 105d between fully closed and fully open positions.

Gate 121d has two shoulders 131d,131d′ with release slots 126′″,126″″, seal areas 130d,130d′, circular stepped ports 125d,125d′ separated by a wall 127d and a flat-stepped tip 128d. Circular seal areas 130d′,130d′ are provided for seals between gate 121 d and seats 170d, 170d′, port 125d is communicated with port 174d for metering the flow fluid, while a cavity 148d is defined by moving tip 128d vertically and a mating stepped slot 13Sd of a cage 133d for conditioning the flow fluid in volume, cage 133 d is disposed in a hole 119d and secured by a flange 197 d, port 125d′ is communicated with port 174d′ for delivering the flow fluid.

Referring to FIGS. 31-34, a valve 100e based on valve 100 comprises a body 101e having a cylindrical neck opening 102e extended to an inlet passageway 104e and an outlet passageway 105e respectively with two seat pockets 107e,170e′ for receiving seats 170e, 170e′, A closure member 120e having a stem 124e and a gate 121e is movably disposed in neck opening 102e with two surfaces 122e,122e′ for throttling flow fluid volume through inlet passageway 104e, seat ports 174e,174e′ and outlet passageway 105e between fully closed and fully open positions.

Gate 121e has circular seal areas 130e,130e′, eccentrically circular step ports 125e,125e′ separated by a wall 127e and a circular step tip 128e disposed in a mating circular step hole 119e for a volume throttling. Seal areas 130e′,130e′ are provided for seals between gate 121e and seats 170e,170e′, port 125e is communicated with port 174e for metering the flow fluid, port 12Se through a stepped link port 129e on tip 128e is connected to hole 119e, while port 125e′ through a step link port 129e′ on tip 128e is connected to hole 119e, a cavity 148e is defined by tip 128e and step hole 119e for conditioning the flow fluid in volume, port 125e′ is communicated with port 174e′ for delivering the flow fluid.

Referring to FIGS. 35-42, a valve 100f based on valve 100 comprises a three way body 101f having a cylindrical neck opening 102f with two seat pockets 107f,170f respectively receiving seat rings 170f,170f, two inlet passageways 104f, 104 f and an outlet passageway 105 f, a closure member 120f having a stem 124f and a gate 121f is movably disposed in neck opening 102f for controlling a fluid mixing ratio between first fluids from inlet passageway 104f and second fluids from inlet passageway 104f between fully closed and fully open positions.

Gate 121f comprises two shoulders 131 f, 131 f respectively with two release slots 126f″, 126f″, circular seal areas 13 Of, 130f, two eccentric ports 125f, 125f separated by a wall 127f. Seal areas 130f,130f are provided for seals between gate 124f and seats 170f,170f′, port 125f is communicated with port 174f for metering the flow fluid from inlet passageway 104f, port 125f through link ports 129f is connected to a slot 135f of a cage 133f, cage 133f with a boss 136f having multiple link ports 134f is extended to outlet passageway 105f. Port 125f′ is communicated with port 174f for metering the flow fluid from inlet passageway 104f, port 125f through link ports 129f is connected to slot 135f of cage 133f, a cavity 148f is defined by moving gate 121f and slot 135f of cage 133f for mixing the flow fluid in volume, cage 133f with boss 136f having multiple link ports 134f to outlet passageway 105f is provided for conditioning and delivering the flow fluid.

Referring to FIGS. 43-46, a valve 100g based on valve 100 comprises a three way body 101g having a cylindrical neck opening 102g with two seat pockets 107g,170g′ respectively receiving a seat 170g, a water spray ring 230, three inlet passageways 104g, 104g′, 104g″ and two outlet passageways 105g,105g′. A closure member 120g having a stem 124g and a gate 121g is movably disposed in neck opening 102g for controlling flow fluid from inlets passageway 104g, 104g′,104g″, 104g′″ through opening 102g and seat ports 174g,174g′ to outlet 10Sg passageway between fully closed and fully open positions.

Gate 121g has a circular seal area 130g, a porous port 125g connected to a porous link port 129g, seal areas 130g is provided for a seal between gate 121g and seat 170g, port 125g is communicated with port 174g for metering the flow fluid from inlet passageway 104g at a temperature at T1, port 125g is connected opening 102g through port 129g, opening 102g is provided for conditioning fluids from ports 129g, outlet passageway 105g and inlet passageway 104g′ is provided for circulating the flow fluid in opening 102g to keep a temperature at T2, spray ring 230g having a groove 233g to inlet passageway 104g″ is disposed in pocket 170g′ for injecting flow fluid through a porous wall 231, porous port 232g to keep a temperature at T3 before entering into outlet passageway 105g, inlet passageway 104g′″ is provided with fluid nozzles (not shown) for controlling temperature at T4 if required for further reduction of temperature.

Referring to FIGS. 47-55, a valve 100h based on valve 100 comprises a body 101h having a cylindrical neck opening 102h with two seat pockets 107h,170h′, respectively receiving seats 170h,170h′, an inlet passageway 104h and an outlet passageway 105h with a noise/cavitation reducer 200. A closure member 120h having a stem 124h and a gate 121h with two overlap circular flow ports 125h,125h′ is movably disposed in neck opening 102h for throttling flow fluid with a dual equal percentage flow pattern from inlets passageway 104h through seats 170h, 170h′ to outlet passageway 105h between fully closed and fully open positions.

Reducer 200 comprises a set of pipes 210a,210b,210c and 210d in a concentric manner and a shock absorber 220 inserted in pipe 21 Od for reducing noise and cavitation, each of outside surfaces 214a, 214b, 214c, 214d in pipes 210a, 210b, 210c, 210d respectively includes multiple parallel grooves 218a,218b,218c,218d and multiple walls 219a,219c,219c,219d, multiple slot 217a, 217b,217c,217d for forming multiple 90 degree, zigzag passages from an inlet 201 to an outlet 202 for gradually dissipating flow energy and insulting noise resource from outlet passageway 105h, each of inside surfaces 215a,215b,215c,215d respectively with a step 216a, step 216b, step 216c, step 216d is provided with a press fit for a telescopically concentric assembly, so such an arrangement of each of pipes 210a, 210b, 210c, 210d are provided for generating the sine vibrations at different phase, so those vibrations can cancel each.

Shock absorber 220 comprises a retaining ring 225, a front piston 221 with an o ring 224, a spring 223 and a back piston 222 with an 0 ring 224 for stabilizing the flow fluid pressure in outlet passageway 105h. A pipe 210e based on 210a can be constructed with additional radial ports for liquid and anti-cavitation applications, finally reducer 200 can be installed in ball 251 as a control unit 250 for rotary throttling or any flow control applications.

Referring to FIGS. 56-60, a valve 100j based on valve 100 comprises an body 101j having a partial cylindrical neck opening 102j with two flat mating surfaces 118j,118j′ constructed with cylindrical slots 106j,106j′ in an opposite direction receiving respectively two support bars 145j,145j′. A closure member 120j movably disposed in neck opening 102j comprises a gate 121j having two flat mating surfaces 122j,122j′ constructed with two cylindrical slots 126j,126j′ engaged respectively with support bars 146j,146j′ for throttling flow fluid between fully closed and fully open positions, closure member 120j with two the identical diameter stem 124j,124j′ is disposed in body 101j and covered by a bottom flange 197j with a stem seal 190j and a top bonnet 150j with stem seal 190j, so with a balanced arrangement of two stem 124j,124j′, the actuation force is required much less for operating valve 100j.

### Advantages

From the description above, a number of advantage of some embodiments of my trunnion control gate valve become evident
1. Sealability. For the first time in the valve history, this valve is fully metal-sealed in both static and dynamic manner, there is no temperature barrier or limit by seal materials like graphite, PEEK and PTFE, the seal capacity can take on working temperature up to 1450 F or more, the sealing surfaces can be flat like flange sealing surface, body joint sealing surface or cylindrical like shaft seal surface, with seat sealing surface of fine surface 16 RMS or special coatings gold, sliver and nickel, stem leakage can be between 3-50 ppm, since the seal assembly in the valve is self energized and pressure assistant seal, the all seal materials are the same, there is no constant local adjustment for the whole valve So the seals can last 5 to 30 years and away beyond any existing seal system in the valve industries.
2. Durability. With the novel gating mechanism, the load under pressure is shifted from the gate and seat in the conventional gate valve to the gate, support bars and body in this valve, the seat seal can be upstream seal which can further reduce operation force, with a balanced bottom stem and spring support bars, the operation force will greatly reduce, as result the wearing and tearing due to the friction and vibration can be further reduced, in meanwhile, all seals and support bars are self energized to compensate any wearing, with all benefits of the invention, the valve can last 5 to 30 years without replacement or readjustment.
3. Reliability. High operational reliability is based on the closure member which is only one moving part with fixed joint between the gate and stem, the movement of gate is accomplished by the gating mechanism with spring support bars between the slots of the body and gate, there is no chance that any foreign particle can prevent the gate from moving, moreover there are additional two redundancy for the gating mechanism; the cylindrical mating surface between the gate and body cylindrical neck opening and the flat seal surfaces between the seats and gate, while high seal reliability is based on two seat seals and one joint seal between body and bonnet and one stem seal, each seal assembly has at least three external seal contact surfaces and four internal contact surfaces, the stem seal has multiple seal rings, the number of redundancy can be 4 to 6, there is no valve ever developed which has such a high level of reliability like this valve in this invention.
4. Efficiency. The volume throttling mechanism with the four-step process; sealing, metering, conditioning and delivery in this invention greatly increase the efficiency, at full opening, the flow capacity is the same as standard size valve, while between full closed and opening, the valve can handle flow with over 1000 psi pressure drop and velocity under 200 ft/s, the conventional control valve with anti-cavitation feature has about half of flow capacity of standard size valve, moreover the operation forces in this valve is about ¾ of conventional valve due to the novel gating mechanism, spring support bars and balanced stem design, finally because the four-step process, even the delivery part of the gate wearing out in most case, this valve can used for shutoff and throttling in comparison with conventional two valves which include one for shutoff and other for throttling, the value of this valve increases considerably while cost still the same.
5. Versatility. This valve can be used for both shutoff and throttling in term of function and used in refiners, power plants, oil/gas drilling on surface, shale fracking and subsea operation, engine fuel delivery systems and chemical plants in term of markets, finally it can handle corrosive fluid, fluid mixed with solid particle, steam and mixed fluid with oil and gas in term of median content.
6. Robustness This valve can sustain multiple extreme conditions that no other valve can do, such as under fast elevated working temperature and high pressure, high pressure fluid with solid particle and corrosive additive, high temperature with highly oxidative fluid, high pressure drop with high temperature, the novel gating mechanism shift the load from between seat and gate to gate and body provides highly flexible but strong compensation system to handle the thermal expansion, wearing, deformation and to keep high precision gating position, while G ring metal seals is other advantage to compensate any wearing and deformation to keep good seals, moreover with spring energizing sleeves, the valve can handle catalytic hard particles in refiner process, high pressure fracking fluid for shale fracking operation.
7. Low cost. Simple structure of this valve make the manufacturing process very easy and inexpensive, the body can be simply fabricated by welding, forging and casting, a turning operation is required for the neck opening of body while cylindrical slot of body and gate can be accomplished by either drilling or milling operations, the stem and gate can be made out two and mounted together or one integral part, finally the cavitation reducer is made out of arranged of pipes, no expensive drilling like conventional reducers, only turning and milling operations are required.

### CONCLUSION, RAMIFICATIONS AND SCOPE

The present invention provides a long sought solution—“fixing gate” to a fundamental problem “float gate” in the conventional gate valve. The solution is (1) a novel gating mechanism includes a pair of spring round bars disposed between cylindrical slots between opening and the gate, the bar can be made out of AISI-0175, Allay 6150, Inconel 750 and 718, stainless steel 17-7, 301 and 302 (2) a pair cylindrical mating surfaces between valve body neck opening and gate cylindrical edges (3) closure member with a fixed joint between a stem and a gate or stem as an integral part of gate. The solution not only simplifies the manufacturing process, but also enhance the gate strength, reliability and mobility with the spring bars for compensating any misalignment or thermal expansion in both an ambient temperature and high temperature at one application, since the movement happens between the gate and spring bar, any replacement will be easy and inexpensive, in addition the gate valve can performs like the ball valve with float seats with upstream seal and has a single or double piston effect, more importantly the gate seat would not support a weight of the gate and stem unlike a ball valve seat, so the structure will increase the seat life tremendously in large size or high pressure class applications, as a result the seat replacement is much easy in comparison with top entry ball valve, with additional hardened face treatment on spring bars and the gate, this valve will last very long time up to 5 to 30 years, above all, this solution enable this gate valve to play a key role in control valves for server service or multiple extreme conditions with the simple, robust and reliable structure.

The present invention provides a great solution for solid particle proof application, this solution provides a short sleeve energized by disc spring with no gap, it overcomes all shortcomings with long sleeves in prior arts, the sleeve is separated from the seat, so any defect or unbalanced loading on sleeve will not effect the seat seal and vice versa, second the sleeve locked with the body release any side load from the seat and can clean up hard buildup or particle on the gate as a scraper. third the back spring in the sleeve keep constant engagement between the gate and sleeve without the gate jamming and block any particle from the valve cavity under high temperature and pressure.

The present invention introduces a new flow control mechanism with three features (1) a four-step throttling process, sealing, metering, conditioning and delivering (2) a volumetric throttling mechanism (3) a dual equal percentage flow pattern. Those features not only stabilize the process and increase accuracy of metering, reduce or eliminate cavitation, noise, but also greatly increase life of the product, it make possible for one valve with two functions; shutoff and flow throttling, any damage on the delivery part will not effect the metering and sealing functions, one of the applications will be an engine fuel metering valve, the erosion is a serious problem for the metering valve under high velocity and temperatures, the plug on conventional metering valve plays as a sealing, metering, conditioning and delivering device, no matter how strong the material it is, it will not last very long, even a small erosion on the plug will greatly effect of accuracy of feeding fuel, as a result the engine performance will be compromised, other application will be the conditioning valve in superheat steam cooling process, the conventional condition valve is based on the globe valve is inefficient with one step throttling, while this control gate vale based on this invention has three stage cooling process (1) at temperature T1, metering (2) at temperature T2, mixing/circulation/conditioning/delivery (3) at temperature T3, spraying/mixing (4) at temperature T4 spraying/mixing, such a process can greatly increase cooling efficiency, reduce the steam energy loss, save water and energy, the water from T2 can be up-used for steam regeneration or down—used as part of spraying water at T3. Finally for process control applications, dual equal percentage flow pattern will save lots of operation cost and setup cost for a known set point, since any increment around a set point is very small and fine, the control loop is much stable.

The present invention discloses other breakthrough achievement—A metal G ring, the metal materials for C cover rings include AISI-0175, Allay 6150, Inconel 750 and 718, stainless steel 17-7, 301 and 302, while the material of I base ring can be any metal material, the coating for the cover C ring includes gold, sliver, nickel and PTFE and other materials, the metal G ring comprises four internal seal surfaces and three external seal surfaces for both static and dynamic seals applications under internal and external pressures beyond the capacities all existing sealing device can provide. First it combine a preset compression seals with two base surfaces and three external surfaces between C ring and I ring and pressures energize seals between two surfaces on I ring and C ring, second it breaks the temperature limit from −100 to 1000 F, third it provides a dynamic seal under high temperature and high pressure, fourth it will last from 5 to 30 years without any replacement under high temperature, while nonmetal seal material will deteriorate or age under sever service or multiple extreme conditions, so the applications with G ring will be subsea flow control system for 25 years life time or, nuclear power plant for 60 years life time, or jet engines or rocket engines for millions cycle or high reliable mission without replacement or failure.

The noise/cavitation reducer in this invention provides a revolutionized method, a vibration self canceling mechanism, it completely change the focus from dissipating the energy between fluid-solid interaction to dissipating the energy between solid-solid interaction, such a method is much more controllable and efficient than the traditional method, although the traditional method is used to transfer fluid energy to solid, but in the end, the most energy dissipates through interaction between solids, such a design will greatly reduce the material and size of the reducer and improve the performance.

Although the description above contains many specifications, these should not be construed as limiting the scope of the invention but as merely providing illustration of some of the presently preferred embodiments of this invention.

Thus, the scope of the invention should be determined by the appended claims and their legal equivalents, rather than by the examples given.

What is claimed is:

1. A valve, comprising:
a body comprising an inlet passageway, an outlet passageway, and a slot;
a closure member movable within the slot between a first position where the inlet passageway is in fluid communication with the outlet passageway, and a second position where fluid communication between the inlet passageway and the outlet passageway is prevented by the closure member;
wherein the closure member includes a stem portion and a gate portion, wherein the gate portion includes a port extending therethrough, and wherein the stem portion and the gate portion are formed as a single integral piece.

2. The valve of claim 1,
wherein the gate portion includes a pair of gate slots;
wherein the slot in the body includes a pair of cylindrical slots; and
wherein the valve further comprises a pair of hollow, tubular support bars disposed within the slot of the body; and
wherein each support bar is disposed within one of the cylindrical slots and one of the gate slots.

3. The valve of claim 2, wherein the gate slots of the gate portion are configured to slidingly engage the support bars when the closure member is transitioned between the first position and the second position.

4. The valve of claim 2, wherein the support bars are made of at least one of the group consisting of: AISI-0175, Alloy 6150, Inconel, and stainless steel.

5. The valve of claim 3, further comprising:
a bonnet mounted to a top surface of the body;
wherein the bonnet includes a base ring and the top surface of the body includes a groove,
wherein the base ring is received within the groove; and
wherein a cover ring including a C-shaped cross-section is disposed about the base ring such that an internal surface of the cover ring is engaged with the base ring and an external surface of the cover ring is engaged with the groove.

6. The valve of claim 5, wherein the bonnet includes a stem hole that slidably receives the stem portion of the closure member therethrough.

7. The valve of claim 1, further comprising a reducer disposed within the outlet passageway configured to reduce at least one of noise and cavitation within fluid flowing through the outlet passageway.

8. The valve of claim 7, wherein the reducer comprises a plurality of pipes arranged concentrically with one another along an axis;
wherein each pipe includes an inner surface and an outer surface;
wherein the outer surface of each pipe includes a plurality of circumferentially extending axially spaced walls that define a plurality of circumferentially extending axially spaced grooves; and
wherein each wall includes a plurality of axially extending wall slots circumferentially arranged about the axis.

9. The valve of claim 8, wherein the wall slots extending through each wall are misaligned with the wall slots of the immediately axially adjacent wall along the outer surface of each pipe.

10. The valve of claim 9, wherein the reducer further comprises a shock absorber disposed within an innermost of the plurality of pipes.

11. The valve of claim 10, wherein the shock absorber comprises:
a first piston;
a second piston; and
a spring disposed axially between and engaging each of the first piston and the second piston.

12. A closure member for a valve, the closure member comprising:
a stem portion extending along an axis; and
a gate portion, wherein the gate portion includes a port extending therethrough;
wherein the stem portion and the gate portion are integrally formed as a single piece.

13. The closure member of claim 12, wherein the gate portion includes a pair of planar surfaces and a pair of cylindrical surfaces, wherein the planar surfaces are radially opposite one another about the axis, and wherein the cylindrical surfaces are radially opposite one another about the axis.

14. The closure member of claim 13, wherein each of the cylindrical surfaces includes an axially extending gate slot.

15. The closure member of claim 14, wherein each gate slot is cylindrical in cross-section.

16. A valve, comprising:
a body comprising an inlet passageway, an outlet passageway, and a slot;
a closure member movable within the slot between a first position where the inlet passageway is in fluid communication with the outlet passageway, and a second position where fluid communication between the inlet passageway and the outlet passageway is prevented by the closure member; and
a bonnet mounted to a top surface of the body, wherein the bonnet includes a stem hole;
wherein the bonnet further includes a base ring and the top surface of the body includes a groove, wherein the base ring is received within the groove, and wherein a cover ring including a C-shaped cross-section is disposed about the base ring such that an internal surface of the cover ring is engaged with the base ring and an external surface of the cover ring is engaged with the groove;
wherein the closure member is a monolithic member comprising a stem portion and a gate portion, wherein the gate portion includes a port extending therethrough;
wherein the stem portion is slidably received within the stem hole of the bonnet and the gate portion is slidably received within the slot of the body; and
wherein the gate portion includes a pair of gate slots, wherein the slot in the body includes a pair of cylindrical slots, wherein the valve further comprises a pair of hollow, tubular support bars disposed within the slot of the body, and wherein each support bar is disposed within one of the cylindrical slots and one of the gate slots.

17. The valve of claim 16, further comprising a reducer disposed within the outlet passageway;
wherein the reducer comprises a plurality of pipes arranged concentrically with one another along an axis;
wherein each pipe includes an inner surface and an outer surface;
wherein the outer surface of each pipe includes a plurality of circumferentially extending axially spaced walls that define a plurality of circumferentially extending axially spaced grooves; and
wherein each wall includes a plurality of axially extending wall slots circumferentially arranged about the axis.

18. The valve of claim 17, wherein the wall slots extending through each wall are misaligned with the wall slots of the immediately axially adjacent wall along the outer surface of each pipe.

19. The valve of claim 18, wherein the reducer further comprises a shock absorber disposed within an innermost of the plurality of pipes.

20. The valve of claim 19, wherein the shock absorber comprises:
a first piston;
a second piston; and
a spring disposed axially between and engaging each of the first piston and the second piston.
